(19) United States
(12) Patent Application Publication
(10) Pub. No.: US 2008/0038554 A1
(43) Pub. Date: Feb. 14, 2008

(54) Media

(75) Inventor: Alan David Cole Cantwell, Aston (GB)

Correspondence Address: The Weintruab Group, 32000 Northwestern Highway, Suite 240, Farmington Hills, MI, 48334, US

(73) Assignee: BRIGHTWATER ENGINEERING LIMITED, Letchworth Garden Cit;y, Hertfordshire (GB)

(21) Appl. No.: 11/662,049

(22) PCT Filed: Sep. 8, 2005
(86) PCT No.: PCT/GB05/03460

§ 371 Date: Sep. 21, 2007

(30) Foreign Application Priority Data
Sep. 8, 2004 (GB) 0419901.4

(51) Int. Cl. C02F 3/10

(52) U.S. Cl. 428/402; 210/263; 210/807; 264/141; 425/113

(57) ABSTRACT

Plastic particles of a selected one of various shapes are usage in a floating media bed of a biological aerated flooded filter. They may be manufactured by injection moulding or by an extrusion-and-chopping method comprising advancing molten plastics through a channel-form extrusion die slot 30, cooling the extruded plastics in water, and chopping-off transversely by a die head face cutter 34 pieces of the cooled channel-form plastics, the distribution of the volumetric rate of flow of the plastics over the outlet mouth of the die slot 30 being such that the external surface of the base of the cooled channel-form plastics is longitudinally convex.

This invention relates to apparatus for and a process of producing particles for inclusion in a media bed; particles for inclusion in a media bed; and a method of use of the particles.

A known type of wastewater treatment system is biological aerated flooded filters (BAFFs). To achieve high effluent quality, these systems do not require any solids filtration or settlement stage after the biological treatment stage, unlike submerged aerated filter (SAF) systems which do. A primary feature of a floating media BAFF system is that a restrained (fixed position), floating bed of granular plastics media is trapped within a reaction vessel by an open-mesh retaining grid. Wastewater containing soluble and suspended bio-degradable substances is allowed to flow through the media, to be purified by biomass, i.e. micro-organisms trapped by or adhering to the media. A known floating media BAFF system is the “BIOBEAD”® system disclosed in W091/18658. Other BAFF variants may use heavier-than-water, sunken media. Oxygen is supplied to the micro-organisms which grow within the media, allowing the bio-chemical reaction to proceed. The supply of oxygen can be provided as air, gaseous oxygen and/or dissolved nitrate. The product of purification is increase of biomass and other trapped solids, which periodically have to be removed. An important feature of the “BIOBEAD”® system is the media bed cleaning method whereby the media bed becomes fluidised and thus disassembled under the action solely of a higher flow air scour. The efficiency of cleaning facilitates good loading and oxygen transfer characteristics as well as facilitating good ‘unblocking’ capability should the media bed be overloaded following solids overload, excessive coagulant dosing, screenings ingress, or removal of extra-cellular polysaccharides caused by shock-loaded biomass.

A major cost element of the floating media BAFF systems is the cost of the plastics media which is determined by the weight of plastics used. Improvements have been made to the level of surface roughness of the media by using various blends of polyolephines with other surface roughening agents to increase effectiveness, i.e. allow higher loading and quicker start-ups by providing better retention of the micro-organisms performing purification.

The function of the media in a floating media BAFF system is to:

1. provide niches where micro-organisms can attach and grow to form the biomass;

2. provide buoyancy to the biomass which is heavier than water and would normally sink to the bottom of the reactor vessel;

3. provide constricted flow paths where suspended solids can be trapped by filtration;

4. provide free volume where biomass and trapped solids can accumulate but be protected from shear induced by flow of gas and liquid;

5. provide flow resistance so that liquid and air flows are laterally uniform and increase the mean retention time within the reactor vessel;

6. provide mixing/turbulence to enhance diffusion of organic material, dissolved oxygen (or other oxygen source) and reaction products to and from the active biomass;

7. retain sufficient biomass on the media after cleaning, such retention being determined by the size, shape and surface roughness of the media.

The standard “BIOBEAD”® media particles are each essentially cylindrical in shape. They are constituted from polyolephine material plus additives to improve surface roughness through surface cracking induced by shear, or through evolution of gas causing craters on the plastics surface as it leaves the extrusion die. This essentially cylindrical shape is able to be produced by an extrusion plus chopping process rather than a moulding, machining or etching process, so as to minimise production cost.

WO-A-91/18658 discloses that the media particles are, for example, 1 to 10 mm., preferably 2 to 5 mm., in maximum dimension and are preferably of polyethylene or polypropylene. It discloses that other materials with a suitable buoyancy achieved by inclusions of air pockets may also be used; examples of such materials being expanded polyethylene or foams made from synthetic or natural rubbers such as polyisobutyl rubbers. Also disclosed is that it is often preferred that the particles should have a shape which allows biomass to be trapped or attached: essentially cylindrical particles may have helical or linear elongate surface grooves, i.e. being star-like or crenellated in cross-section, or be tube-like; all of which forms, or other forms, preferably with included angles from which biomass cannot be removed easily, being able to be produced by extrusion or moulding of suitable material, and chopping. It further discloses that the particle surface, alternatively or in addition, may be roughened by abrasion, milling or chemical treatment, e.g. with powders, polymers, or solvent emulsions, or by the inclusion of solid material such as chalk, alumina, carbon or talc; chalk or other water-soluble materials being particularly suitable since they dissolve to create a puffed surface which encourages biomass adhesion. It further comments that sponge-like and sintered forms of suitable polymers are also known and can be used.

WO-A-91/11396 discloses a moving bed, non-filtering system for purification of waste water, in which the media particles are disclosed as being, most suitably, chopped-off pieces of an extruded tube having internal partition walls longitudinally of the tube and fins longitudinally on the outside of the tube. The tube can be of circular or rectangular cross-section.

According to one aspect of the present invention, there is provided a method of production of particles for inclusion in a media bed, comprising advancing molten plastics through a channel-form extrusion die slot, cooling the extruded plastics, and chopping-off transversely pieces of the cooled channel-form plastics, the distribution of the volumetric rate of flow of the plastics over the outlet mouth of the die slot being such that the external surface of the base of the cooled channel-form plastics is longitudinally convex.

According to a second aspect of the present invention, there is provided extrusion die apparatus for use in production of particles for inclusion in a media bed, said apparatus including a channel-form extrusion die slot the outlet mouth of which has a cross-section of a shape which is of lesser width at its middle than at its ends.

Owing to these two aspects of the invention, it is possible to produce relatively cheaply particles for inclusion in a media bed, which particles can loosely interengage in the media bed.

According to a third aspect of the present invention, there is provided a particle for inclusion in a media bed, said particle being of a channel form of substantially constant cross-section.

According to a fourth aspect of the present invention, there is provided a particle for inclusion in a media bed, said particle being of a crescent shape which reduces in cross-section from its middle towards its ends, that cross-section being substantially without any re-entrant portion of its external profile.

Owing to these aspects of the present invention, it is possible to achieve that this particle, when included in a media bed with other identical particles, tends to interengage with them loosely.

According to a fifth aspect of the present invention, there is provided a process of treatment of waste water, comprising causing the waste water to flow through a stationary media bed comprised of media particles each of a substantially arcuate shape and loosely interengaging each other.

Owing to this aspect of the invention, it is possible to improve the treatment of the waste water, because there can be increased voidage for containing biomass, whilst the pathways for the waste water through the bed can be more tortuous, thereby improving mass transfer by greater forced convection, and more contact points can be created, thereby to promote filtration.

According to a sixth aspect of the present invention, there is provided a particle for inclusion in a media bed for odour removal and comprised of plastics and an odour-removing substance.

The odour-removing substance, which is preferably calcium carbonate, may be either blended into the plastics melt or applied as a coating to the plastics melt.

Owing to this aspect of the invention, it is possible to improve the robustness of the particles in the media bed, compared with a known arrangement in which the particles are individual sea shells.

The shape of the particle is preferably such that the media in the bed has multiple convex and concave surfaces positioned to create voidage for containing biomass and contact points for promoting filtration. In this way, individual media particles can be largely kept apart from each other but still provide a large number of narrow annular passages within the matrix which can filter-out and trap solids. The particles are advantageously arcuate in shape, so as to interengage in bulk to create relatively high voidage. A desirable feature is that particles should not fit together so closely as to create low voidage and impede mass transfer and throughflow. At the other extreme, too much voidage would both reduce surface area for attachment of micro-organisms and not provide the constrictions necessary to filter out solids. The arcuate shape can be created by an extrusion plus chopping method using a conventional extrusion machine with a water 5 submerged face cutter. Although the extrusion machine may be conventional, its extrusion die slot would not be. The die slot would advantageously be of curved, channel-shape, typically arcuate, e.g. semi-circular, with the width of the outlet mouth of the slot greater at each end than at its middle, to compensate for higher molten plastics flow at its middle. These two features create curvature in the extruded plug in one or two dimensions so that the shape when chopped forms a ‘croissant’ or arcuate shape.

In order that the invention may be clearly and completely disclosed, reference will now be made, by way of example, to the accompanying drawings, in which:

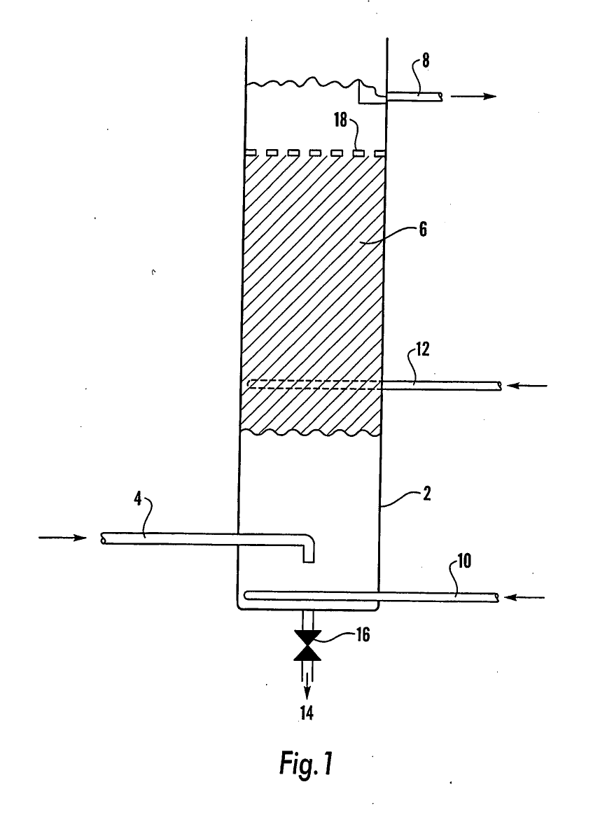

FIG. 1 is a diagrammatic side elevation of a wastewater treatment unit of a floating media BAFF system,

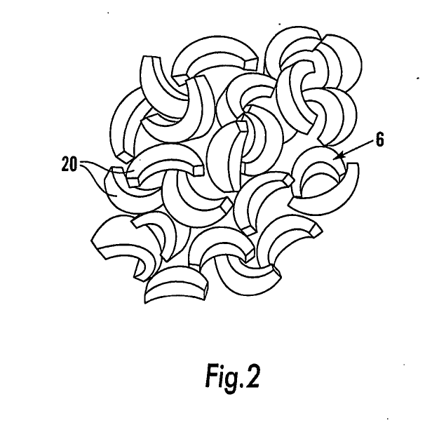

FIG. 2 is a view of particles in a media bed of the unit,

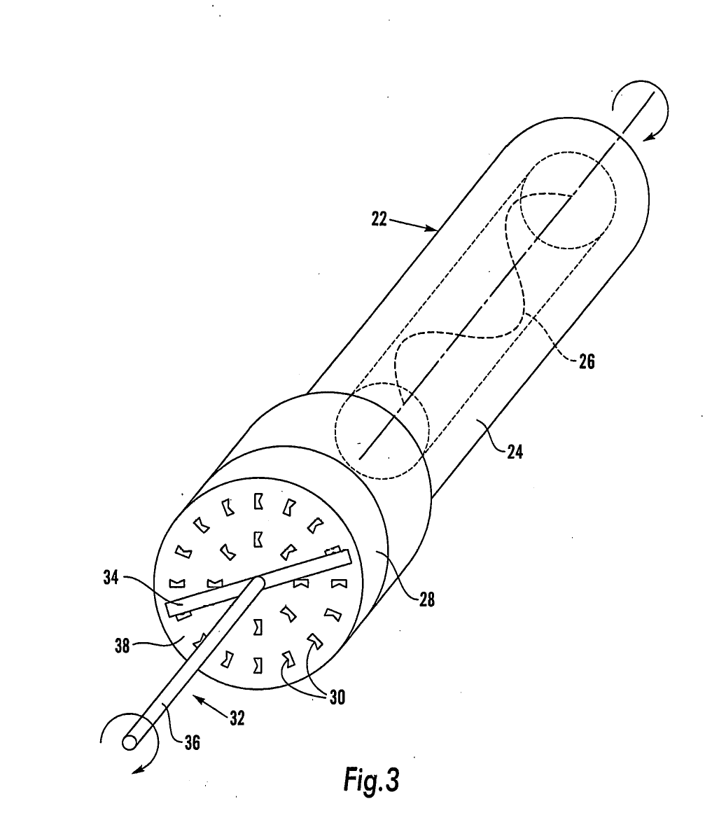

FIG. 3 is a diagrammatic perspective view from above of an extrusion-plus-chopping system employed in producing media particles for such a bed,

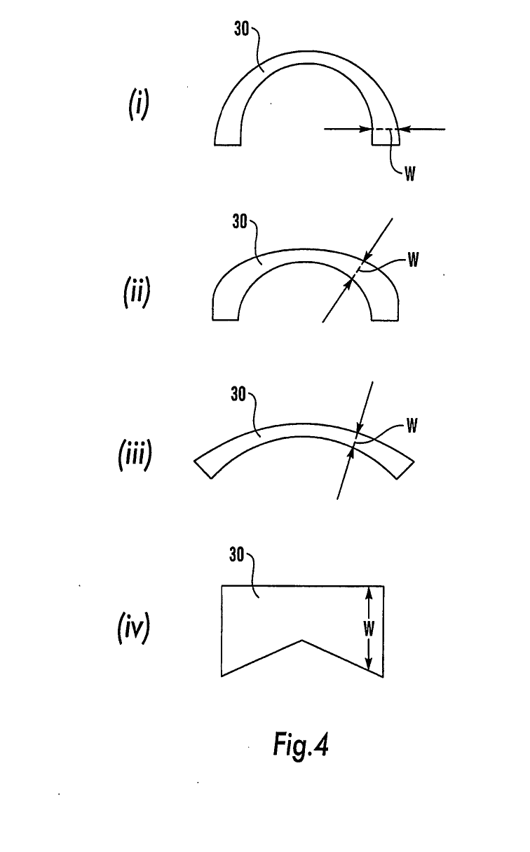

FIGS. 4(i) to (iv) are front elevations of the exit mouths of respective differing die slots usable in the system of FIG. 3, and

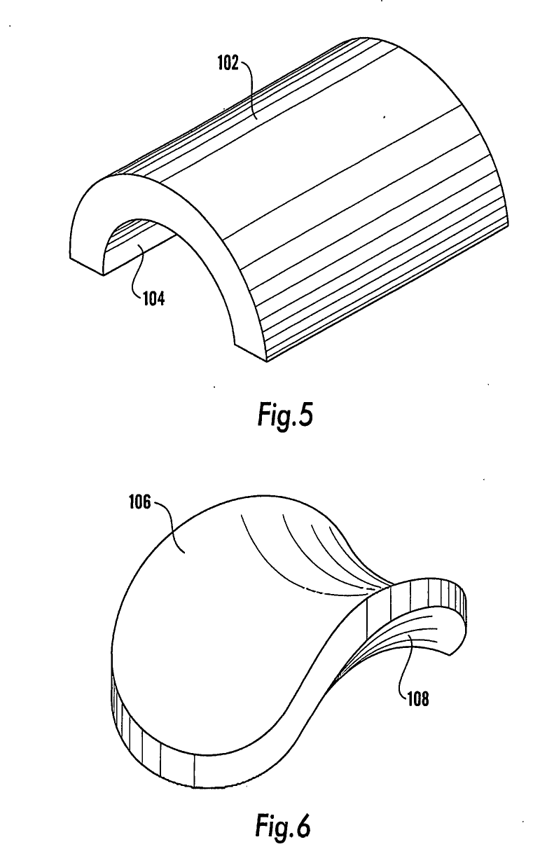

FIGS. 5 to 10 show respective differing versions of a particle for inclusion in the media bed.

Referring to FIG. 1, the wastewater treatment unit shown therein comprises a tank 2 having an inlet 4 for wastewater to be purified, a floating media packed bed 6, an outlet 8 for the purified wastewater, an air sparging inlet pipe 10 for scouring air, an air inlet sparging pipe 12 for aerating air, a desludging line 14 containing a valve 16, and a media-retaining grid 18.

FIG. 2 shows a very small portion of the media bed 6, with the substantially identical particles 20 thereof being approximately banana-shaped.

The extrusion-plus-chopping system illustrated in FIG. 3 includes an extruder 22 including an extruder body 24 containing an eccentric extrusion screw 26, the body 24 terminating in an interchangeable die head 28 formed with die slots 30 identical to each other. The extrusion-plus-chopping system includes, after the extruder 22, a chopper 32 including a die head face cutter 34 rotated about the axis of the die head 28 by a drive shaft 36.

The outlet mouths of the die slots 30 illustrated in FIG. 3 are each as per FIG. 4(iv), but they may be of any one of the other shapes shown in FIG. 4, depending upon the shape of the particles to be produced. For this reason, the die head 28 is replaceable by a selected die head having die slots with appropriately shaped outlet mouths. It will be noted that each of the outlet mouths shown in FIGS. 4(i) to (iii) has opposite longitudinal edges which are respectively concavely and convexly curved, whereas the outlet mouth shown in Figure (iv) has opposite longitudinal edges which are respectively substantially a straight line and rectilinearly convex.

An important feature of each of these outlet mouth shapes is that the width W of each mouth is greater at each end of the mouth than at the middle of the mouth, to compensate for the higher molten plastics volumetric flow rate at the middle of the length of the mouth than at the ends of the length of the mouth. There is cooling water (not shown) covering the outlet end face 38 of the die head 28, so that, as the channel-form plastics extrusions enter the cooling water, they are rapidly solidified and curl. The plastics used can be given a rough surface finish by the same process as described in EP-B-1036771.

Referring to FIG. 5, the particle shown therein, which is one of a multitude of substantially identical particles to be included in the media bed, is in the form simply of an arcuate, substantially semi-cylinder of substantially constant cross-section. It has a semi-cylindrical outer surface 102 and a parallel, semi-cylindrical inner surface 104 and has been extruded from a correspondingly shaped, channel-form die slot.

Referring to FIG. 6, the particle is again of arcuate shape, but here in the form of a saddle having concavo-convex surfaces 106 and 108 which are substantially parallel with each other.

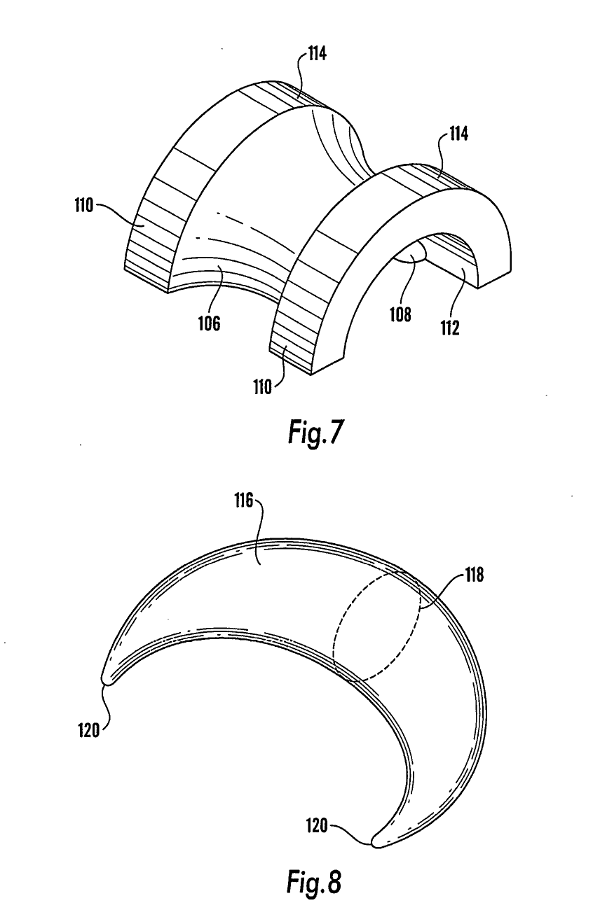

Referring to FIG. 7, the version shown here is arcuate, but of a differing saddle form, in which the substantially parallel, concavo-convex surfaces 106 and 108 somewhat merge into substantially semi-cylindrical, outer and inner surfaces 110 and 112 of arcuate, semi-cylindrical end parts 114.

The version shown in FIG. 8 is again arcuate, but in the shape of a “croissant” bread. The particle is defined by a continuous curved surface and is of a gradually reducing, circular cross-section progressing from its middle 118 to its ends 120.

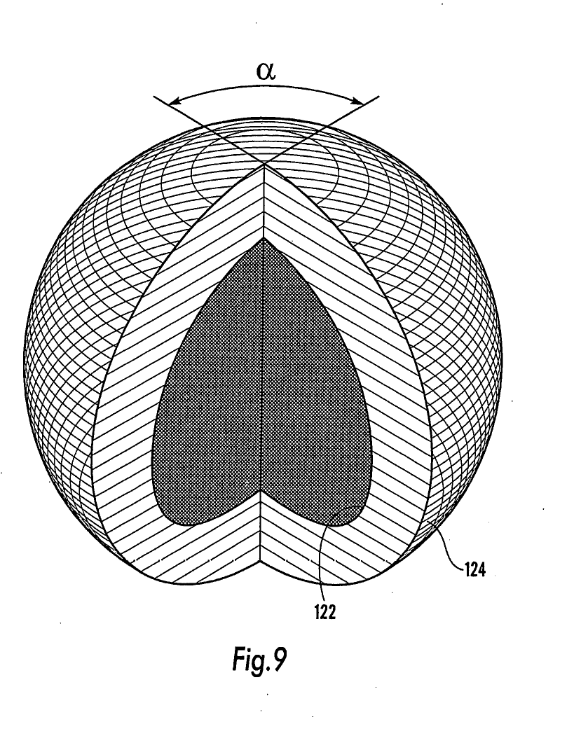

Referring to FIG. 9, the version shown here is in the form of a segment of a hollow sphere, with the segment extending through an angle α of between about 10° and about 270°, preferably about 60° and about 100°, for example 90°, whereby it would be of arcuate shape with part-spherical internal and external surfaces 122 and 124.

A preferred manner of manufacturing the particles shown in FIGS. 6 to 9 would be by injection moulding.

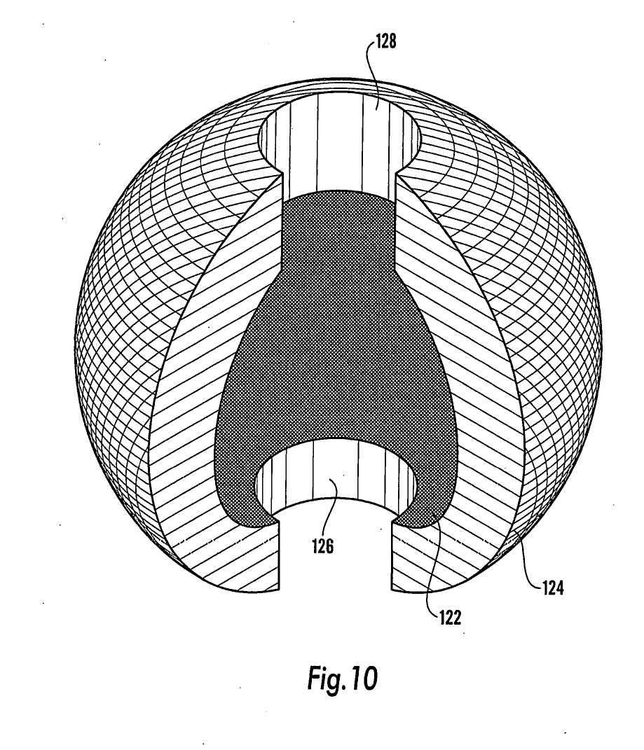

Referring to FIG. 10, the version shown here differs from that shown in FIG. 9 solely in that the co-axial cores have been omitted from respective opposite poles of the part-sphere, so as to leave respective co-axial, part-cylindrical surfaces 126 and 128 at the respective ends of the arcuate shape.

To manufacture the version shown in FIG. 10 with a segment angle of approximately a right-angle, it is preferred to employ the extrusion-plus-chopping system according to FIG. 3, but with the die slot outlet mouth being according to FIG. 4(i), i.e. channel-shaped and substantially semi-cylindrical, with the width of the outlet mouth of the slot greater at each end than at its middle, to compensate for higher molten plastics volumetric flow rate at the middle of the length of the mouth than at the ends of the length of the mouth.

Compared with the die slot 30 of FIG. 4(i), the die slots 30 of FIGS. 4(ii) and (iii) give flatter concave internal and convex external surfaces of the particles, whilst the die slot of FIG. 4(iv) gives rectilinearly concave internal surfaces and cylindrically convex external surfaces of the particles.

With particles according to FIG. 10 having a segment angle of 90°, and manufactured in the same manner as just described, the volume of media produced per tonne of plastics can be 15% higher than with the standard “BIOBEAD”® media particles which are essentially cylindrical in shape. Moreover, the particles according to FIG. 10 should give a superior process performance in terms of upflow velocity, loading rate treatable, and final effluent quality. The voidage is normally about 40% with the standard “BIOBEAD” media, but can be above 50% and up to 65% or so with the FIG. 10 media particles.

The use of plastics media particles with re-entrant surface curvature can give high voidage and a high number of particle-to-particle contact points with narrow passages among the particles. Particularly effective shapes are believed to be those described above with reference to FIGS. 6 to 10, giving high loading performance in floating media BAFF systems such as the “BIOBEAD”® system.

A channel-shaped extrusion die slot of part-circular cross-section and with an outlet mouth which is wider at its ends than at its middle promotes a substantially equal distribution of volumetric flow rate over the mouth area and thus not only curling of the extruded plug but also equal material thickness of that curved, channel-form plug.

Although the versions of FIGS. 6 to 10 have been described as being for inclusion in a media bed of a floating media BAFF system for the treatment of waste water, they are also usable to provide a heavier-than-water media bed in a sunken media BAFF system.

Furthermore, the versions described with reference to FIGS. 6 to 10 are usable in media beds outside the field of treatment of waste water, for example in odour removal scrubbers. It is particularly advantageous if there is blending or coating of the plastics melt with an odour removal substance, especially calcium carbonate.

1-35. (canceled)

36. A method of production of particles for inclusion in a media bed, comprising advancing molten plastics through a channel-form extrusion die slot, cooling the extruded plastics, and chopping-off transversely pieces of the cooled channel-form plastics, the distribution of the volumetric rate of flow of the plastics over the outlet mouth of the die slot being such that the external surface of the base of the cooled channel-form plastics is longitudinally convex.

37. A method according to claim 36, wherein said molten plastics includes an odor-removal substance.

38. A method according to claim 37, wherein said substance is calcium carbonate.

39. A method according to claim 36, wherein said external surface is transversely convex.

40. A method according to claim 36, wherein said external surface is cylindrical.

41. Extrusion die apparatus for use in production of particles for inclusion in a media bed, said apparatus including a channel-form extrusion die slot the outlet mouth of which has a cross-section of a shape which is of lesser width at its middle than at its ends.

42. Apparatus according to claim 41, wherein said outlet mouth has opposite longitudinal edges which are respectively concave and convex.

43. Apparatus according to claim 42, wherein said edges are respectively concavely and convexly curved.

44. Apparatus according to claim 41, wherein said outlet mouth has opposite longitudinal edges which are respectively substantially a straight line and rectilinearly convex.

45. A particle for inclusion in a media bed, said particle being of a channel form of substantially constant cross-section, being arcuate in shape, and being in the form of a saddle in which substantially parallel, concavo-convex, major surfaces somewhat merge into substantially semi-cylindrical, outer and inner surfaces of arcuate, semi-cylindrical end parts.

46. A particle for inclusion in a media bed, said particle being of a channel form of substantially constant cross-section and being in the shape of a segment of substantially a hollow sphere of which co-axial cores have been omitted from respective opposite poles of the part-sphere.

47. A particle according to claim 46, wherein said segment extends through an angle of between about 60° and about 100°.

48. A particle for inclusion in a media bed, said particle being of a crescent shape which reduces in cross-section from its middle towards its ends, that cross-section being substantially without any re-entrant portion of its external profile.

49. A particle according to claim 48 and defined by a continuous curved surface and of a gradually reducing, circular cross-section progressing from its middle to its ends.

50. A particle for inclusion in a media bed, said particle being in the form of a segment of a hollow sphere.

51. A particle according to claim 50, wherein said segment extends through an angle of between about 60° and about 100°.

52. A media bed comprised of a multitude of particles produced by a method according to claim 36.

53. A biological aerated flooded filter system including a media bed according to claim 52.

54. A particle for inclusion in a media bed for odor removal and comprised of plastics and an odor-removing substance.

55. A process of treatment of wastewater, comprising causing the wastewater to flow through a stationary media bed comprised of media particles each of a substantially arcuate shape and loosely interengaging each other.
